(19) United States
(12) Patent Application Publication
(10) Pub. No.: US 2008/0146715 A1
(43) Pub. Date: Jun. 19, 2008

(54) Aqueous Mineral Suspensions

(75) Inventors: Jun Yuan, Kathleen, GA (US); Tony May, Macon, GA (US); Mikel Dean Smith, Tennille, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Pigments, Inc., Roswell, GA (US)

(21) Appl. No.: 11/814,782

(22) PCT Filed: Jan. 27, 2006
(86) PCT No.: PCT/US06/03097

§ 371 Date: Jul. 25, 2007

Related U.S. Application Data
(60) Provisional application No. 60/646,981, filed on Jan. 27, 2005.

(51) Int. Cl. C08K 3/34; C08K 3/26; C08L 33/06; C08L 29/04

(52) U.S. Cl. 524/425; 524/447; 524/451; 524/560; 524/557

(57) ABSTRACT

Disclosed herein are slurries comprising at least one particulate inorganic material dispersed in an aqueous medium, at least one anionic polymeric dispersant in a solids content ranging from 0.1% to 3% by weight, wherein the at least one anionic polymeric dispersant is partially neutralized by at least one monovalent neutralizing agent, and at least one inorganic dispersant in an amount ranging from 0.3% to 5% by weight relative to the total weight of the inorganic solids in the slurry. Also disclosed are methods of making such slurries and products comprising or made from such slurries.

This application claims priority to U.S. Provisional Patent Application No. 60/646,981, filed Jan. 27, 2005.

Disclosed herein are dispersed mineral slurries comprising at least one anionic polymeric dispersant partially neutralized by at least one monovalent neutralizing agent and at least one inorganic dispersant. Methods of making such dispersed mineral slurries and products comprising or made from such slurries are also disclosed.

Aqueous mineral slurries have been widely used for the production of paper coatings, fillers and paints, to name just a few products. Such uses often require the aqueous mineral slurries to have a relatively high solids content, which can lead to high viscosities and consequently cause problems in handling and processing of the slurries. To improve the viscosity and to facilitate handling and processing, such as grinding, at a high solids content, a dispersant is usually added to the slurries. A wide variety of dispersants are known. For example, anionic polymers, such as polyacrylates, may be used. However, polyacrylates may be expensive. In addition, there is currently a severe shortage of polyacrylates on the world market. For at least these reasons, there is a strong need to develop a method for producing dispersed mineral slurries with a high solids content while using a reduced amount of polyacrylates.

While the prior art describes various methods of dispersing mineral slurries, there is still room for improvement. For example, U.S. Pat. No. 6,315,867 discloses a method of dispersing mineral slurries using a combination of 100% sodium neutralized polyacrylate and an inorganic dispersant, such as sodium hexametaphosphate. However, the mineral slurries produced using this method do not always have the desired viscosity.

Therefore, there remains a need to develop a method for producing dispersed mineral slurries with a high solids content while using a reduced amount of polyacrylates. The present inventors have found that the viscosity of a mineral slurry can be significantly improved using a combination of at least one anionic polymer dispersant, which is either partially neutralized by a monovalent neutralizing agent or is neutralized by a mixture of at least one monovalent neutralizing agent and at least one polyvalent neutralizing agent, and at least one inorganic dispersant.

Accordingly, in one aspect, the present disclosure relates to a slurry comprising:
at least one particulate inorganic material dispersed in an aqueous medium;
at least one anionic polymeric dispersant in a solids content ranging from 0.1% to 3% by weight, wherein the at least one anionic polymeric dispersant is partially neutralized by at least one monovalent neutralizing agent; and
at least one inorganic dispersant in an amount ranging from 0.3% to 5% by weight relative to the total weight of the inorganic solids in the slurry.

As used herein, the term “slurry” means a dispersion of finely divided solid particles in a liquid medium, typically an aqueous medium such as water.

The at least one particulate inorganic material is chosen from those known in the art, for example, kaolin, calcium carbonates, such as ground calcium carbonate (GCC) and precipitated calcium carbonate (PCC), talcs, metal hydroxides such as aluminum hydroxides, satin white (hydrated double sulfate of aluminum and calcium) and natural or synthetic gypsums. The at least one particulate inorganic material is present in a solids content of, for example, at least 30% by weight, ranging, for example, from 40% to 80% by weight, such as from 68% to 78% by weight.

The at least one anionic polymeric dispersant as disclosed herein can be chosen, for example, from polymeric dispersants comprising at least one group chosen from a hydroxyl group, an amido group, a carboxyl group, a sulfo group and a phosphono group, and alkali metal and ammonium salts thereof. For example, partially sodium neutralized polymers of acrylic or methacrylic acid or copolymers of acrylic or methacrylic acid with an alkyl acrylate or an alkyl methacrylate, polyacrylamide, poly(vinyl alcohol), and partially sodium neutralized oligostyrenesulfonate can be used. Non-limiting examples include polyacrylates and copolymers, ligosulfonates, and naphthalene sulfonates.

In one embodiment, the at least one anionic polymeric dispersant as disclosed herein comprises at least one carboxyl group. Examples of such anionic polymeric dispersant comprise at least one monomeric unit chosen from (meth)acrylic acid, itaconic acid, crotonic acid, isocrotonic acid, fumaric acid, maleic anhydride, aconitic acid, mesaconic acid, sinapic acid, undecylenic acid, angelic acid, and hydroxyacrylic acid.

The polymeric dispersants can have a molecular weight of, for example, less than 20,000, ranging, for example, from 1,000 to 10,000, such as from 3,000 to 9,000.

As used herein, the term “partially neutralized” means that the at least one anionic polymeric dispersant is less than 100% neutralized by at least one monovalent neutralizing agent. For example, the at least one anionic polymeric dispersant may be neutralized from 10% to 90% by a monovalent neutralizing agent, such as from 20% to 70%, and further such as from 30% to 60%.

As disclosed herein, the at least one monovalent neutralizing agent can be chosen, for example, from alkali metal cations, such as sodium and potassium, ammonia and primary, secondary and tertiary aliphatic and cyclic amines, such as ethanolamines, mono and diethylamine, cyclohexylamine and methylcyclohexylamine. In one embodiment, the at least one monovalent neutralizing agent is sodium cation.

The at least one anionic polymeric dispersant can further be partially neutralized by at least one polyvalent neutralizing agent. In one embodiment, the at least one anionic polymeric dispersant can be fully neutralized, but at least a portion of the neutralization is by a polyvalent neutralizing agent.

The at least one polyvalent neutralizing agent as disclosed herein can be chosen, for example, from alkali earth metal cations, such as calcium and magnesium, and aluminum and zinc. In one embodiment, the at least one polyvalent neutralizing agent is chosen from divalent cations, such as calcium.

In one exemplary embodiment, the anionic polymeric dispersant is 30% neutralized by sodium cation. Such an anionic polymeric dispersant can, for example, be purchased from Ciba under the tradename Dispex 6340. In another exemplary embodiment, the anionic polymeric dispersant is 30% neutralized by sodium cation and 70% neutralized by calcium cation.

The at least one anionic polymeric dispersant is present in a solids content ranging from 0.1% to 3% by weight, for example, from 0.1% to 1% by weight, such as from 0.1% to 0.5% by weight, further such as from 0.1% to 0.4% by weight, and even further such as from 0.1% to 0.25% by weight.

As disclosed herein, the at least one inorganic dispersant is chosen from those commonly used in the art. For example, the at least one inorganic dispersant may be chosen from silicates such as sodium silicate, lithium silicate, and ammonium silicate. The at least one inorganic dispersant may be also be chosen from water soluble condensed phosphates such as sodium hexametaphosphate, trisodium phosphate, tetrasodium phosphate, tetrasodium pyrophosphate, sodium tripolyphosphate, and sodium acid pyrophosphate.

The at least one inorganic dispersant is present in an amount ranging from 0.3% to 5% by weight, such as from 0.3% to 3% by weight, further such as from 0.5% to 1% by weight, and even further such as from 0.7% to 1% by weight, relative to the total weight of the inorganic solids in the slurry. In various embodiments, the inorganic dispersant comprises sodium hexametaphosphate in amounts ranging from 0.3% to 5% by weight, such as from 0.3% to 3% by weight, further such as from 0.5% to 1% by weight, and even further such as from 0.7% to 1% by weight, relative to the total weight of the inorganic solids in the slurry.

The pH of the slurry as disclosed here may be, for example, greater than 7, such as ranging from 8 to 10. In one embodiment, the pH of the slurry as disclosed herein is not greater than 10.5. The pH can be adjusted by commonly used acidifying agents, such as phosphoric acids, or basifying agents, such as calcium hydroxide.

In another aspect, the present disclosure relates to a method for making an aqueous mineral slurry, comprising:

combining at least one particulate inorganic material with

at least one anionic polymeric dispersant in a solids content ranging from 0.1% to 3% by weight, wherein the at least one anionic polymeric dispersant is partially neutralized by at least one monovalent neutralizing agent, and

at least one inorganic dispersant in an amount ranging from 0.3% to 5% by weight relative to the total weight of the inorganic solids in the slurry.

Another aspect of the present disclosure provides a method of grinding a particulate inorganic material comprising:
combining the particulate inorganic material with
an aqueous medium,
at least one anionic polymeric dispersant in a solids content ranging from 0.1% to 3% by weight, wherein the at least one anionic polymeric dispersant is partially neutralized by at least one monovalent neutralizing agent, and
at least one inorganic dispersant in an amount ranging from 0.3% to 5% by weight relative to the total weight of the inorganic solids in the slurry; and
grinding the aqueous slurry.

Viscosity is a measure of a mineral's resistance to changes in flow. Those having ordinary skill in the art are familiar with typical ways of measuring viscosity, which include, for example, Brookfield viscosity. Brookfield viscometers provide a measure of a mineral slurry's low shear viscosity, expressed in units of centipoise (cps). One centipoise is equal to one centimeter-gram-second unit. (One centipoise is one hundredth (10⁻²) of a poise.) Thus, all other things being equal, a 100 centipoise sample has a lower viscosity than a 500 centipoise sample.

Further disclosed herein are products, such as paper coatings, polymers, and paints, made from or comprising the aqueous mineral slurry as disclosed herein.

In one aspect, the present disclosure provides a paper coating comprising the slurry as disclosed herein. The coating can further comprise at least one binder chosen from binders conventionally used in the art. Exemplary binders include, but are not limited to, adhesives derived from natural starch and synthetic binders, including, for example, styrene butadiene, acrylic latex, vinyl acetate latex, styrene acrylic, casein, polyvinyl alcohol, polyvinyl acetate, and mixtures thereof.

Paper and paper board coatings may have different binder levels depending on the end use of the coated product. Appropriate binder levels based upon the desired end product would be readily apparent to the skilled artisan. For example, binder levels can be controlled to allow the surfaces to receive ink without disruption. The latex binder levels for paper or paper board coatings generally range from about 3% to about 30% by weight relative to the total weight of the coating. For example, the at least one binder can be present in an amount ranging from about 3% to about 30%, such as from about 10% to about 30%, by weight relative to the total weight of the coating.

In another embodiment, the present disclosure provides a polymer product comprising the slurry as disclosed herein. The polymer product disclosed herein also comprises at least one polymer resin. The term “resin” means a polymeric material, either solid or liquid, prior to shaping into a plastic article. The at least one polymer resin used herein is one which, on cooling (in the case of thermoplastic plastics) or curing (in the case of thermosetting plastics), can form a plastic material.

The at least one polymer resin, which may be used herein, may be chosen, for example, from polyolefin resins, polyamide resins, polyester resins, engineering polymers, allyl resins, thermoplastic resins, and thermoset resins.

In another embodiment, the present disclosure provides a paint, such as an aqueous industrial coating, architectural paint, deco paint, or art paint, comprising the slurry as disclosed herein. The paint disclosed herein can further comprise at least one component chosen from binders, such as polymeric binders, for example, water dispersible binders chosen, for example, from polyvinyl alcohol (PVA) and latex; and additives conventionally used in paints, chosen, for example, from surfactants, thickeners, biocides, defoamers, wetting agents, dispersants, and coalescents. The paint disclosed herein can also comprise at least one pigment chosen, for example, from TiO₂ and calcium carbonate.

All percentages and amounts expressed herein are by weight. All amounts, percentages, and ranges expressed herein are approximate.

The present invention is further illuminated by the following non-limiting examples, which are intended to be purely exemplary of the invention. In the examples shown below, the following abbreviations are used:

SHMP=sodium hexametaphosphate dry powder,

#/t=number of pounds per ton on a dry weight basis,

Dispersant A=a commercial 100% sodium neutralized polyacrylate dispersant sold by Ciba under the tradename Dispex 2695,

Dispersant B=a 30% sodium neutralized/70% calcium neutralized polyacrylate dispersant (which was produced by further neutralizing a commercial 30% sodium neutralized polyacrylate dispersant sold by Ciba under the tradename Dispex 6340 with calcium cation to 70% calcium neutralized),

Dispersant C=a commercial 30% sodium neutralized polyacrylate dispersant sold by Ciba under the tradename Dispex 6340.

### EXAMPLES

### Example 1

In this example, ground calcium carbonate was slurried in water at the solids content and with dispersants shown in the Table I below, wherein the slurry had a particle size distribution such that about 90% by weight of the particles had an Equivalent Spherical Diameter (ESD) of less than 2 microns. The viscosities of the slurry were measured at T0 (0 hours), T1 (1 hour), and T24 (24 hours) on a Brookfield viscometer using a #2 spindle at 20 rpm.

The results are shown in Table I below.

TABLE I

| | Dispersant | Dispersant | SHMP | Solids % | Viscosity (cps) | | |
|---|---|---|---|---|---|---|---|
| | A (#/t) | B (#/t) | (#/t) | (by weight) | T0 | T1 | T24 |
| Control 1 | 27 | — | — | 73 | 95 | 320 | 575 |
| Control 2 | 19 | — | 8 | 70.7 | 1400 | flocculated | |
| Control 3 | 15 | — | 6 | 70.8 | 775 | flocculated | |
| Inventive | — | 15 | 10 | 73 | 105 | 146 | 425 |

As shown in Table I, the inventive slurry comprising partially neutralized polyacrylate dispersant (i.e., Dispersant B) and sodium hexametaphosphate had even better viscosities than Control 1, i.e., the slurry with 100% sodium neutralized polyacrylate dispersant. These improved properties occurred despite the fact that the inventive sample had a lower amount of the polymeric dispersant than the comparative samples. Therefore, partially neutralized polyacrylate dispersant was used together with sodium hexametaphosphate to reduce the amount of the polyacrylate dispersant.

On the other hand, as shown in Table I, the combination of 100% sodium neutralized polyacrylate dispersant (i.e., Dispersant A) with sodium hexametaphosphate in Control 2 and 3 did not lead to slurries with desired viscosities.

### Example 2

In this example, ground calcium carbonate with a median particle size (D50) of about 15 μm was sand-ground in an attrition grinder to a particle size distribution (PSD) such that about 90% by weight of the particles had an ESD of less than 2 μm with the aid of the dispersants shown in Table II below. The ground product was then screened through 200 mesh and was slurried in water with the solids content adjusted as shown in the Table II below. The viscosities of the slurry were then measured at T0 (0 hours), T1 (1 hour), and T24 (24 hours) on a Brookfield viscometer using a #2 spindle at 20 rpm.

The results are shown in Table II below.

TABLE II

| | Dispersant | Dispersant | Dispersant | SHMP | Slurry PSD | | Solids % | | | |
|---|---|---|---|---|---|---|---|---|---|---|
| | A (% by | B (% by | C (% by | (% by | (% of less | pH of | (by | Viscosity (cps) | | |
| | weight) | weight) | weight) | weight) | than 2 μm) | slurry | weight) | T0 | T1 | T24 |
| Control 1 | 0.54 | — | — | — | 90 | 9.5 | 73 | 95 | 320 | 575 |
| Control 2 | 0.32 | — | — | 0.6 | 92 | 9.4 | 74 | 1680 | gelled | |
| Control 3 | 0.32 | — | — | 0.5 | 92 | 9.3 | 74 | 2080 | gelled | |
| Control 4 | 0.38 | — | — | 0.28 | 93 | 8.7 | 71 | 1400 | gelled | |
| Control 5 | 0.38 | — | — | 0.15 | 94 | 9.3 | 73 | 900 | gelled | |
| Control 6 | — | — | — | 1.25 | 83 | 9.0 | 62 | 3600 | gelled | |
| Control 7 | 0.12 | 0.2 | — | 0.6 | 90 | 9.0 | 74 | 290 | 1810 | gelled |
| Control 8 | — | 0.54 | — | — | 90 | 8.7 | 72 | 105 | n.a. | 1080 |
| Control 9 | — | 0.5 | — | — | 87 | 8.7 | 72 | 65 | 310 | n.a. |
| Inventive 1 | — | 0.38 | — | 0.5 | 90 | 9.0 | 73 | 105 | 205 | 1040 |
| Inventive 2 | — | 0.32 | — | 0.6 | 90 | 9.1 | 75 | 210 | 930 | 2650 |
| Inventive 3 | — | — | 0.35 | 0.6 | 90 | 8.9 | 74 | 145 | 515 | n.a. |

As shown in Table II, the inventive slurries (Inventive 1, 2, and 3) comprising partially neutralized polyacrylate dispersant (i.e., Dispersant B or Dispersant C) and sodium hexametaphosphate have similar viscosities as Control 1, i.e., the slurry with 100% sodium neutralized polyacrylate dispersant, or Control 8 or 9, i.e., the slurry with partially sodium neutralized polyacrylate dispersant. These improved properties occurred despite the fact that the inventive samples had a lower amount of the polymeric dispersant than the comparative samples. Therefore, partially neutralized polyacrylate dispersant was used with sodium hexametaphosphate to reduce the amount of polyacrylate dispersant.

On the other hand, as shown in Table II, the combination of 100% sodium neutralized polyacrylate dispersant (i.e., Dispersant A) with sodium hexametaphosphate in Control 2, 3, 4, and 5 did not lead to slurries with desired viscosities. In addition, in Control 6, sodium hexametaphosphate by itself did not provide desired viscosity to the slurry. Further, the combination of 100% sodium neutralized polyacrylate dispersant and partially neutralized polyacrylate dispersant (e.g., Dispersant C) with sodium hexametaphosphate did not provide the desired viscosity as the combination of partially neutralized polyacrylate dispersant (e.g., Dispersant C) with sodium hexametaphosphate.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention.

Other embodiments of the invention will be apparent to those skilled in the art from consideration of the specification. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A slurry comprising:
at least one particulate inorganic material dispersed in an aqueous medium;
at least one anionic polymeric dispersant in a solids content ranging from about 0.1% to about 3% by weight, wherein said at least one anionic polymeric dispersant is partially neutralized by at least one monovalent neutralizing agent; and
at least one inorganic dispersant in an amount ranging from about 0.3% to about 5% by weight relative to the total weight of the inorganic solids in the slurry.

2. The slurry according to claim 1, wherein said at least one particulate inorganic material is chosen from kaolin, calcium carbonates, and talc.

3. The slurry according to claim 2, wherein said calcium carbonates are chosen from ground calcium carbonate and precipitated calcium carbonate.

4. The slurry according to claim 1, wherein said at least one particulate inorganic material is present in a solids content of at least about 30% by weight.

5. The slurry according to claim 4, wherein said at least one particulate inorganic material is present in a solids content ranging from about 40% to about 80% by weight.

6. The slurry according to claim 5, wherein said at least one particulate inorganic material is present in a solids content ranging from about 68% to about 78% by weight.

7. The slurry according to claim 1, wherein said at least one anionic polymeric dispersant is present in a solids content ranging from about 0.1% to about 1% by weight.

8. The slurry according to claim 7, wherein said at least one anionic polymeric dispersant is present in a solids content ranging from about 0.1% to about 0.5% by weight.

9. The slurry according to claim 8, wherein said at least one anionic polymeric dispersant is present in a solids content ranging from about 0.1% to about 0.4% by weight.

10. The slurry according to claim 9, wherein said at least one anionic polymeric dispersant is present in a solids content ranging from about 0.1% to about 0.25% by weight.

11. The slurry according to claim 1, wherein said at least one anionic polymeric dispersant is chosen from polymeric dispersants comprising at least one group chosen from a hydroxyl group, an amido group, a carboxyl group, a sulfo group and a phosphono group.

12. The slurry according to claim 11, wherein said at least one anionic polymeric dispersant is chosen from polymers of acrylic acid, polymers of methacrylic acid and copolymers of acrylic or methacrylic acid with an alkyl acrylate or an alkyl methacrylate, polyacrylamide, poly(vinyl alcohol), and oligostyrenesulfonates.

13. The slurry according to claim 12, wherein the oligostyrenesulfonates are chosen from lignosulfates and naphthalene sulfonates.

14. The slurry according to claim 12, wherein said at least one anionic polymeric dispersant comprises polyacrylates and copolymers thereof.

15. The slurry according to claim 1, wherein said at least one monovalent neutralizing agent is chosen from alkali metal cations, ammonia and primary, secondary and tertiary aliphatic and cyclic amines.

16. The slurry according to claim 15, wherein said at least one monovalent neutralizing agent is sodium cation.

17. The slurry according to claim 1, wherein said at least one anionic polymeric dispersant is further partially neutralized by at least one polyvalent neutralizing agent.

18. The slurry according to claim 17, wherein said at least one polyvalent neutralizing agent is chosen from alkali earth metal cations, aluminum cation, and zinc cation.

19. The slurry according to claim 18, wherein said alkali earth metal cations are chosen from calcium and magnesium cations.

20. The slurry according to claim 1, wherein said at least one anionic polymeric dispersant has a molecular weight of less than about 20,000.

21. The slurry according to claim 20, wherein said at least one anionic polymeric dispersant has a molecular weight ranging from about 1,000 to about 10,000.

22. The slurry according to claim 21, wherein said at least one anionic polymeric dispersant has a molecular weight ranging from about 3,000 to about 9,000.

23. The slurry according to claim 1, wherein said at least one anionic polymeric dispersant is neutralized by at least one monovalent neutralizing agent to an extent ranging from about 10% to about 90%.

24. The slurry according to claim 23, wherein said at least one anionic polymeric dispersant is neutralized by at least one monovalent neutralizing agent to an extent ranging from about 20% to about 70%.

25. The slurry according to claim 24, wherein said at least one anionic polymeric dispersant is neutralized by at least one monovalent neutralizing agent to an extent ranging from about 30% to about 60%.

26. The slurry according to claim 17, wherein said at least one anionic polymeric dispersant is about 30% sodium neutralized and about 70% calcium neutralized polyacrylate.

27. The slurry according to claim 1, wherein said at least one inorganic dispersant is chosen from silicates and water soluble condensed phosphates.

28. The slurry according to claim 27, wherein said silicates are chosen from sodium silicate, lithium silicate, and ammonium silicate.

29. The slurry according to claim 27, wherein said water soluble condensed phosphates are chosen from sodium hexametaphosphate, trisodium phosphate, tetrasodium phosphate, tetrasodium pyrophosphate, sodium tripolyphosphate, and sodium acid pyrophosphate.

30. The slurry according to claim 1, wherein said at least one inorganic dispersant is present in an amount ranging from about 0.3% to about 3% by weight relative to the total weight of the inorganic solids in the slurry.

31. The slurry according to claim 30, wherein said at least one inorganic dispersant is present in an amount ranging from about 0.5% to about 1% by weight relative to the total weight of the inorganic solids in the slurry.

32. The slurry according to claim 31, wherein said at least one inorganic dispersant is present in an amount ranging from about 0.7% to about 1% by weight relative to the total weight of the inorganic solids in the slurry.

33. The slurry according to claim 1, wherein said at least one inorganic dispersant is sodium hexametaphosphate in an amount ranging from about 0.3% to about 3% by weight relative to the total weight of the inorganic solids in the slurry.

34. The slurry according to claim 33, wherein said at least one inorganic dispersant is sodium hexametaphosphate in an amount ranging from about 0.3% to about 1% by weight relative to the total weight of the inorganic solids in the slurry.

35. The slurry according to claim 34, wherein the sodium hexametaphosphate is present in an amount ranging from about 0.5% to about 1% by weight relative to the total weight of the inorganic solids in the slurry.

36. The slurry according to claim 1, wherein the pH of the slurry is greater than about 7.

37. The slurry according to claim 36, wherein the pH of the slurry ranges from about 8 to about 10.

38. A method for making a slurry, comprising:
combining at least one particulate inorganic material with
at least one anionic polymeric dispersant in a solids content ranging from about 0.1% to about 3% by weight, wherein the at least one anionic polymeric dispersant is partially neutralized by at least one monovalent neutralizing agent, and
at least one inorganic dispersant in an amount ranging from about 0.3% to about 5% by weight relative to the total weight of inorganic solids in the slurry.

39. A method of grinding a particulate inorganic material comprising:
combining the particulate inorganic material with
an aqueous medium,
at least one anionic polymeric dispersant in a solids content ranging from about 0.1% to about 3% by weight, wherein the at least one anionic polymeric dispersant is partially neutralized by at least one monovalent neutralizing agent, and
at least one inorganic dispersant in an amount ranging from about 0.3% to about 5% by weight relative to the total weight of the inorganic solids in the slurry; and
grinding the aqueous slurry.

40. A slurry comprising:
at least one particulate inorganic material dispersed in an aqueous medium;
at least one anionic polymeric dispersant in a solids content ranging from about 0.1% to about 3% by weight, wherein said at least one anionic polymeric dispersant is partially neutralized by at least one monovalent neutralizing agent; and
at least one condensed phosphate dispersant in an amount ranging from about 0.3% to about 5% by weight relative to the total weight of the inorganic solids in the slurry.

41. A composition comprising:
at least one particulate inorganic material dispersed in an aqueous medium;
at least one anionic polymeric dispersant in a solids content ranging from about 0.1% to about 3% by weight, wherein said at least one anionic polymeric dispersant is partially neutralized by at least one monovalent neutralizing agent; and
at least one inorganic dispersant in an amount ranging from about 0.3% to about 5% by weight relative to the total weight of the inorganic solids in the slurry.

42. (canceled)

43. (canceled)

44. The composition of claim 41 as a paper coating.

45. The composition of claim 41 as a polymer product.

46. The composition of claim 41 as a paint.
